(19) United States
(12) Patent Application Publication
(10) Pub. No.: US 2009/0070228 A1
(43) Pub. Date: Mar. 12, 2009

(54) SYSTEMS AND METHODS FOR E-COMMERCE AND MOBILE NETWORKS FOR PROVIDING PURCHASE EXPERIENCES OF FRIENDS IN A SOCIAL NETWORK

(76) Inventor: Guy Ronen, Mevaseret Zion (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 11/853,844

(22) Filed: Sep. 12, 2007

(51) Int. Cl. G06Q 30/00; G06F 17/30; G06F 17/40

(52) U.S. Cl. 705/26

(57) ABSTRACT

Methods, for facilitating electronic commerce using a social network, including: registering users on a social-network product-review site, wherein each user can be connected to other users by designating the other users as friends; identifying product purchases, of the users, made in merchant locations; collecting purchase details, and associated-user identities; sending a notification to an associated user requesting a user-specific product review from the associated user upon the associated user receiving the purchase details associated with the associated user; obtaining the user-specific product review and permissions from the associated user, wherein the permissions designate to share the user-specific product review and a relevant associated-user identity with associated-user friends; determining product-related information being accessed in various locations by a product-seeking user; ascertaining an identity of the product-seeking user; and presenting related-product reviews, based on the product-related information and related permissions, of user-related friends to the product-seeking user in the various locations.

### FIELD AND BACKGROUND OF THE INVENTION

The present invention relates to systems and methods for electronic commerce (e-commerce) and mobile networks that utilize a social network of acquaintances of a user to collect and provide the user information on purchase experiences of the individuals in the social network.

Commercial transactions are commonly being conducted using e-commerce systems on the Internet. In a typical e-commerce transaction, a user can access a product/service merchant's website in order to purchase a product or service that the user is interested in. The term “product” is used hereinafter to refer to a product and/or service provided for sale by a merchant.

In order to enhance the “purchasing experience” of customers (i.e. the users) and merchants, prior-art systems and methods are available for providing information about the customers and the merchants (to each other and to other customers). For example, many websites allow a customer to rate his/her purchase experience with a given merchant or product. Such rating information is typically shared with other prospective customers within the merchant's website (e.g. amazon.com).

Other third-party websites collect information from customers about their purchase experiences regarding various products and/or merchants. In such customer-review websites, a customer is not able to provide product and/or merchant feedback at the time of purchase. Instead, the customer must access a third-party website some time after the purchase is made in order to provide such information. The information is then available to prospective customers who access the third-party website for reading customer reviews of products and/or merchants (e.g. epinions.com)

Other prior-art systems present customer reviews based on “social filters” (e.g. a customer interested in buying a camera can choose to see customer reviews of novice or expert photographers, such a service is provided by powerreviews.com). Customers can be characterized based on the customer's browsing/purchasing behavior (within a given merchant website). Customers with similar browsing/purchasing behavior are grouped. The customer then receives recommendations for items browsed/purchased by other customers within a group.

A prior-art example by Gutta et al. International Patent Publication No. WO 03/030528 A3 (hereinafter referred to as Gutta '528) hereby incorporated by reference as if fully set forth herein, teaches personalized recommender database using profiles of others. However, Gutta '528 is primarily focused on learning the preferences of a user from various data using methods common to search engines.

A prior-art example by Pronk et al, International Patent Publication No. WO 2007/063466 A1 (hereinafter referred to as Pronk '466) hereby incorporated by reference as if fully set forth herein, teaches a method and apparatus for generating a recommendation for at least one content item. However, Pronk '466 is primarily focused on content channels (e.g. television and music), not e-commerce systems.

A prior-art example by Gutta, International Patent Publication No. WO 03/043332 A2 (hereinafter referred to as Gutta '332) hereby incorporated by reference as if fully set forth herein, teaches a method and apparatus for recommending items of interest to a user based on recommendations for one or more third parties. However, Gutta '332 is primarily focused on television channels, not e-commerce systems. The presentation system of Gutta '332 resides in a set-top box (STB) connected to a television, not in a distributed-network environment. Furthermore, details about how recommendations are collected are not provided.

A prior-art example by Albanese et al., US Patent Publication No. 2004/0111360 A1 (hereinafter referred to as Albanese '360) hereby incorporated by reference as if fully set forth herein, teaches a system and method for personal and business information exchange. However, Albanese '360 is primarily focused on comparing and matching similar profiles based on user purchasing, but not within the context of a social network.

A prior-art example by Macdonald-Korth et al., International Patent Publication No. WO 2005/122077 A2 (hereinafter referred to as Macdonald-Korth '077) hereby incorporated by reference as if fully set forth herein, teaches system and methods for electronic commerce using personal and business networks. However, Macdonald-Korth '077 is primarily focused on providing buyer/seller feedback in an on-line auction environment under one unifying website. Macdonald-Korth '077 does not teach systems and methods for linking users across multiple merchant websites.

Websites known in the prior art that also provide a single platform for obtaining product reviews include powerreviews.com and reevoo.com in which users are notified by e-mail to review a recently-purchased product.

Another website known in the prior art is bizrate.com in which merchants are rated based on customer reviews as in other price-comparison websites. The user is invited via e-mail to rate a merchant in the context of the user's purchase experience. This is performed by program code installed in the merchant website and/or through the customer's e-mail receipt, providing an automatic notification at the time of purchase. All ratings are collected into the BizRate system, and presented in the BizRate portal only. This system is limited to rating only merchants. It does not incorporate the user's social network into the scheme, which, among other things, means that the user cannot control with whom the rating information is shared.

Another website known in the prior art is yub.com in which a user makes purchases through the Yub portal. The submission and presentation of reviews is performed in the Yub portal only.

Also known in the prior art are behavior-targeting systems that are installed in e-commerce stores for presenting to users information such as, “People who browsed the items you browsed, also browsed/purchased items: ‘x, y, and z.’” Such systems do not incorporate a user's social network into the scheme.

Other websites known in the prior art provide social-networking environments in which users can selectively share information (e.g. messages, photos, and videos) with other users designated as part of their social network. Some examples of social-network review websites in which users see their friends' reviews of products include: flixster.com, yelp.com, listal.com, shelfari.com, and trustedopinion.com. In these websites, the user has to perform the step of visiting the website in order to submit a review and/or to see their friends' reviews. Such review information can be categorized as user-generated content (UGC, a known term in Web 2.0).

Other websites known in the prior art provide “product widgets” that a user installs in his/her profile in a social network or in his/her blog. The widget presents items that the user might be interested in based on the widget configuration. The user then has to manually configure the widget by adding items of interest from an on-line catalog or search engine. Examples of such websites include: flixster.com, “Myshopping” application provided by secretprices.com, kaboodle.com, favoritethingz.com, and mypicklist.com.

Also known in the prior art are desktop applications that act like a price-comparison website, but track a user's browsing in order to present recommendations (e.g. winbuyer.com). Such systems do not incorporate the user's social network into the scheme.

It would be desirable to have systems and methods for e-commerce and mobile networks that utilize a social network of acquaintances of a user to provide the user information on purchase experiences of the individuals in the social network.

### SUMMARY OF THE INVENTION

It is the purpose of the present invention to provide systems and methods for e-commerce and mobile networks that utilize a social network of acquaintances of a user to provide the user information on purchase experiences of the individuals in the social network.

For the purpose of clarity, several terms which follow are specifically defined for use herein. The terms “purchase details” and “PD” is used herein to refer to identity of a purchased item (i.e. product/service), merchant from whom a user purchased item, the time/date of purchase, the purchase price, return policy of merchant, and delivery time of purchased item. The terms “purchase experience” and “PE” are used herein to refer to information regarding a customer's purchase. For example, the PE can include: purchase details, information regarding interaction with the merchant, user's opinion regarding the purchased item, user's identity, and/or information regarding interaction with the purchased item's manufacturer. The PE can be presented in the form of a rating or review. The PD can serve as the simplest form of PE when shared with friends.

The term “friend” is used herein to refer to a person designated by a user to be a known acquaintance of the user. For example, user A is a friend of user B, if user B designated user A as a friend (i.e. a “first-degree” friend) and vice versa (i.e. both sides have to confirm friendship). Furthermore, the “second-degree” friends of user B are the friends of the friends of user B. Similarly, the “third-degree” friends of user B are the friends of the friends of the friends of user B.

The term “social network” is used herein to refer to a grouping of individuals that designate certain individuals (and vice-versa) as friends. The term “social-network site” is used herein to refer to a site that utilizes a social network to allow users to share information with friends. The terms “triggered UGC” and “TUGC” are used herein to refer to UGC that a system triggers a user to generate.

The term “site-server” is used herein to refer to a server or server farm that maintains operation of a website. The term “end-user system” is used herein to refer to an electronic-communication device operated by an end-user. Examples of end-user systems include: desktop computers, laptop computers, electronic mobile devices, and cellular phones. The term “electronic kiosk” is used herein to refer to an electronic-information station for exchanging information. The electronic kiosk can include display stands, electronic cash registers, and hand-held devices maintained by store or service-provider personnel. The term “merchant portal” is used herein to refer to a site that provides information regarding a plurality of merchants. An example of a merchant portal is the Yellow Pages.

FIG. 1 is a simplified schematic representation of an exemplary social network for a user A, according to preferred embodiments of the present invention. Users B-G are friends of user A (i.e. first-degree friends). Users H-J are second-degree friends of user A. User K is a third-degree friend of user A.

The present invention teaches product-review Blast systems (i.e. product-review social-network site), and methods for implementing such Blast systems, that can operate across a plurality of networks (e.g. websites), and that incorporates a social-network environment into the review-presentation scheme. In the Blast system, a user is identified by the system when the user browses a merchant site. The browsed product- or category-related content is identified by Blast system, and related PE of the user's friends is presented. When a user makes a purchase, the related PD are collected and reported to Blast system. The user is notified to rate or review the purchase, and the PE is collected by Blast system.

In preferred embodiments of the present invention, users may agree to share their PD and/or PE at the time of purchase with the users' friends. The users can either submit their PE at the time of purchase, or are notified by e-mail to provide their PE. The Blast system (hereinafter referred to as “Blast”) can operate in a distributed-network environment with PE being collected and presented in various merchant websites, price-comparison websites, or other network locations (as opposed to only a single portal).

In preferred embodiments of the present invention, Blast presents PE as a component within the framework of a merchant's website, as a banner, as a display-window notification (e.g. pop-up or desktop-application window), as a widget in a social network, or as a message (e.g. SMS). Users do not have to go to a dedicated product-review website to search for PE. PE is presented in the context of the users' circle of friends.

In a preferred embodiment of the present invention, Blast collects PD and PE via a desktop application (DA) that monitors a user's browsing and purchasing activities. The DA can also provide e-mail notification in order to collect PE.

In another preferred embodiment of the present invention, Blast collects PD via a special e-mail address (e.g. userA@Blast.com) that a user provides in purchasing form in an on-line merchant site. Using the Blast e-mail address enables the purchase related e-mail receipt to reach the Blast site. Such a configuration circumvents the need for software installation in the merchant site for collecting PD.

In another preferred embodiment of the present invention, a Blast component that is installed inside the merchant site collects and stores PE and PD, eliminating the need to share PD/PE with the Blast site. This configuration is referred to as a “closed” architecture.

According to the present invention, a user can start an “activity session” in a merchant's website, not necessarily in the Blast portal. When browsing product-related content, Blast presents PE of the user's friends (e.g. related by product category). Blast can also provide cross-merchant product identification in which the products appear in merchant-site categories.

Blast provides automatic notification for reviewing a purchase, consolidates information from various resources, and presents the information to a “circle of friends” in locations users typically visit (e.g. merchant websites and price-comparison websites).

It is noted that there are websites that extend their presentation beyond the social-network site (e.g. Last.fm and mybloglog.com). Last.fm has a widget that exports a user's music profile to any website in which the Last.fm widget is installed. Mybloglog has a widget that allows users to communicate with other Mybloglog users in any website in which the Mybloglog widget is installed.

In another preferred embodiment of the present invention, Blast collects the information that user A purchased a product, and presents the information to the friends of user A. In such a scenario, user A does not have to provide a rating or review (the PE is simply the PD).

In another preferred embodiment of the present invention, Blast automatically “learns” a user's tendency to read the PE of various friends, and correspondingly presents the most relevant PE to the user.

As an example of how Blast generally functions, user A sees the PE of users B and C, if user A is a friend of users B and C, and users B and C agreed to present their PE to user A. In such an example, the PE can be presented in various locations and formats (e.g. merchant websites, price-comparison websites, banners, Blast widget in social-network, SMS, pop-ups, and DA notifications).

PE is collected in one or more of the following ways.
(1) At the time of purchase of a product, or when notified later, a user gives permission to present his/her friends the fact that he purchased the product. This is a variant of reviewing, but there is no need to review, in which just the fact that the item was purchased is presented (i.e. PD are the PE). In such a scenario, there is no additional activity required from the user. Permission is given by one of the following ways depending on the method of purchase:
   (a) in an on-line purchase, permission is provided by a user designation (e.g. marking a check box in the act of purchasing or when notified later);
   (b) in a mobile-network (e.g. cellular-phone) purchase, permission is provided by a mobile-device interface (e.g. SMS, Internet, and voice-response); and
   (c) in an off-line purchase, the merchant asks for the user's permission, and updates the Blast system with the information (via web interface, cellular interface (e.g. SMS, picture of product barcode), voice-response, keypad sequence, and/or magnetic card).
(2) After the purchase is complete, a user receives an automated notification requesting the user to review or rate the purchased product. The user reviews or rates the product, and gives permission to present PE to his/her friends. Notification and review is delivered via e-mail, SMS, messaging system (e.g. Instant Messenger), voice message, Blast widget for social networks and blogs, keypad sequence, Bast DA, Blast widget in starting page (e.g. Netvibes), and/or the Blast site. Both (1) and (2) above are TUGC.
(3) A user adds PE to the Blast system as described by the same communication interfaces as described above. Here, the user has to manually add the PD. In such a scenario, the user may have never purchased the product that he/she is reviewing, or the merchant from whom the product was purchased was not a participating merchant of the Blast system. In this approach, no notification to review the product is provided.

In all the ways of collecting PE described above, the user specifies with whom he/she wants to share the information with. For example, the user can specify to share the information with: all friends, selected friends, second-degree friends, third-degree friends, designated groups of friends (e.g. work friends, family friends, and school friends), or all users. The user can also specify which information he/she wants to share with whom (e.g. PD, rating, review, and/or user identity).

PE can be presented in merchant websites, price-comparison websites, customer-reviews websites, e-commerce portals (e.g. Yellow Pages), start page (e.g. Netvibes), Blast DA, Blast website, search-engine advertising, mobile device, and in an electronic kiosk in an off-line store.

PE can be presented in one or more of the following ways:
(1) next to relevant product (e.g. user A browses a page in which camera X is presented, and sees friends' PE regarding camera X.);
(2) next to relevant category of products (e.g. user A browses a page in which cameras (or camera X) are presented, and sees friends' PE regarding cameras, not necessarily the same cameras that are presented in the page.);
(3) next to products in general (e.g. user A browses a page where cameras are presented, and sees friends' PE regarding various products.);
(4) according to a wish list (e.g. user A places camera X in his/her wish list; User A browses any page, and sees friends' PE regarding camera X.);
(5) according to PE history (e.g. user A purchased camera X a year ago; user A now sees friends' PE regarding products related to camera X (e.g. bags, batteries, and lenses).);
(6) according to friends' PE history (e.g. user A browses camera X; friends of user A purchased camera X and telephone Y; user A sees friends' PE regarding telephone Y.);
(7) according to friends' wish list (e.g. user B is a friend of A; user B places camera X in his/her wish list; user A sees camera X along with a notification that camera X is in the wish list of user B.); and
(8) when a user browses a merchant website, the presented PE can be restricted to only products that are sold by the merchant, or can include product sold by other merchants (e.g. depending on agreement between Blast and merchant). Such a “built-in referral system” enhances the merchant's ability to make cross sales.

PE presented to user A is related to a group of users, according to one or more of ways described below. Two conditions that are required are that the users designated user A as a friend (and vice versa), and that the users permitted to share their PE (or certain details of their PE) with user A. Thus, in this example, the group of users from whom user A receives PE can be:
(1) friends of A;
(2) second-degree friends of user A;
(3) users that user A tends to look at their PE, according to products or group of products (“PE-reading” tendency is automatically learned by Blast (e.g. user A tends to look at PE of user B regarding books. When user A browses books, user A sees PE of user B regarding books in addition to PE from other friends.);
(4) specific users that user A designates; and
(5) specific group of users the user A designates.

Furthermore, Blast identifies users with similar purchasing behavior (i.e. users who purchase the same or similar products), and prompts the users regarding the other identified users, forming the designated users into a sub-community within the Blast system. Purchasing behavior regarding a user is provided to the identified user according to the user's permission designated in the Blast system.

Depending on the Blast configuration, PE can be presented in one or more of the following formats (in addition to the online formats mentioned above):
(1) in a banner (e.g. user A browses a website in which a banner is placed; user A sees his/her friends' PE in the banner.);
(2) in a Blast widget (e.g. user installs Blast widget in the user's profile (e.g. in a social network or blog), and widget presents the user's PE); and
(3) in an off-line (“brick-and-mortar”) merchant store (e.g. PE is presented when user asks for information regarding a product via user's mobile device communicating with Blast system (e.g. SMS, Internet, and picture taken of product barcode in the store), or via an in-store electronic kiosk.).

Users register to the Blast service via a web interface in which the user submits an e-mail address, and designates his/her friends by providing their e-mail addresses. Blast can automatically perform the designation of friends by accessing the user's contact list in his/her e-mail accounts (e.g. MS Outlook), messenger accounts (e.g. MSN messenger, IM, and Skype), and web mail accounts. Another way to designate friends is to supply a list of cellular phone numbers. User's registration can also be performed through a cellular interface (e.g. Internet, SMS, voice-response).

Therefore, according to the present invention, there is provided for the first time a method for facilitating electronic commerce using a social network, the method including the steps of: (a) registering a plurality of users on a social-network product-review site, wherein each user can be communicationally connected to other users by designating the other users as friends; (b) identifying product purchases, of the plurality of users, made in merchant locations; (c) collecting purchase details, of the product purchases, and associated-user identities; (d) sending a notification to an associated user requesting a user-specific product review from the associated user upon the associated user receiving the purchase details associated with the associated user; (e) obtaining the user-specific product review and permissions from the associated user, wherein the permissions designate to share the user-specific product review and a relevant associated-user identity with associated-user friends; (f) determining product-related information being accessed in various locations by a product-seeking user, wherein the various locations include at least one enabled site and the social-network product-review site; (g) ascertaining an identity of the product-seeking user; and (h) presenting related-product reviews, based on the product-related information and related permissions, of user-related friends of the product-seeking user to the product-seeking user in the various locations.

Preferably, the step of identifying is performed in at least one locality selected from the group consisting of: a merchant site, an off-line store, the social-network product-review site, an electronic kiosk, and an end-user system.

Preferably, the merchant locations include localities selected from the group consisting of: a merchant site, an off-line store, and a service-provider location.

Preferably, the step of collecting is performed in at least one locality selected from the group consisting of: a merchant site, an off-line store, the social-network product-review site, an electronic kiosk, and an end-user system.

Preferably, the step of collecting includes transmitting the purchase details and the associated-user identities to the social-network product-review site.

Most preferably, the transmitting is performed using a communication transmittal selected from the group consisting of: an SMS, an e-mail, and a web-interface transmittal, a keypad sequence, and a voice response.

Most preferably, the transmitting is performed by automatically generating a communication transmittal.

Preferably, the associated-user identities include at least one identification selected from the group consisting of: a user name in the social-network product-review site, a user e-mail address, a user phone number, a user address, an end-user system ID, an e-mail address in the social-network product-review site, a magnetic-card ID, a cookie, and a flash shared-object.

Preferably, the steps of collecting and identifying include parsing receipt-related e-mails of the product purchases in order to obtain the purchase details and the associated-user identities.

Most preferably, the receipt-related e-mails are transmitted to the social-network product-review site using an e-mail address in the social-network product-review site.

Preferably, the notification includes at least one communication transmittal selected from the group consisting of: an SMS, an e-mail, a web-interface transmittal, a messaging-service notification, a pop-up window, a desktop application notification, and a voice message.

Preferably, the user-specific product review and the related-product reviews each include at least one item selected from the group consisting of: the purchase details, a portion of the purchase details, a purchase experience, and a portion of the purchase experience.

Preferably, the permissions are configured: (a) to designate which review portions, of the user-specific product review, and which identity portions, of the relevant associated-user identity, to share; and (b) to designate with which user-related friends to share the portions.

More preferably, the portions are presented according to a rule based on a criterion selected from the group consisting of: a user wish list, a friend wish list, a user purchase-experience history, and a friend purchase-experience history.

Most preferably, the rule is configured to be automatically modified based on a user tendency to read certain related-product reviews from certain user-related friends.

Preferably, the product-related information includes at least one item selected from the group consisting of: a product name, a product category, a product search, a product-category search, a product ID, a product barcode, a manufacturer's name, a manufacturer's location, a product review, a product-related article, a merchant name, a merchant category, and a merchant location.

Preferably, at least one enabled site is a locality selected from the group consisting of: a merchant site, a merchant portal, a product-comparison site, a customer-review site, a general-content site, a banner site, a social-network site, a blog site, a start page, a search-engine site, an off-line store, and an electronic kiosk.

Preferably, the steps of determining and ascertaining is performed in at least one locality selected from the group consisting of: a merchant site, a merchant portal, a product-comparison site, a customer-review site, a general-content site, a banner site, a social-network site, a blog site, a start page, a search-engine site, an off-line store, an electronic kiosk, an end-user system, and the social-network product-review site.

Preferably, the identity include at least one identification selected from the group consisting of: a user name in the social-network product-review site, a user e-mail address, a user phone number, a user address, an e-mail address in the social-network product-review site, and a user photo.

Preferably, the step of presenting includes presenting using at least one presentation transmittal selected from the group consisting of: an SMS, an e-mail, a web-interface transmittal, a messaging-service notification, a pop-up window, a desktop application notification, and a voice message.

According to the present invention, there is provided for the first time a system for facilitating electronic commerce using a social network, the system including: (a) a social-network product-review site-server configured: (i) to register a plurality of users, wherein each user can be communicationally connected to other users by designating the other users as friends; (ii) to send a notification to an associated user requesting a user-specific product review from the associated user upon the associated user receiving purchase details associated with the associated user; and (iii) to obtain the user-specific product review and permissions from the associated user, wherein the permissions designate to share the user-specific product review and a relevant associated-user identity with associated-user friends; and (b) a module configured: (i) to identify product purchases, of the plurality of users, made in merchant locations; (ii) to collect the purchase details, of the product purchases, and associated-user identities; (iii) to determine product-related information being accessed in various locations by a product-seeking user, wherein the various locations include at least one enabled site and the social-network product-review site-server; (iv) to ascertain an identity of the product-seeking user; and (v) to present related-product reviews, based on the product-related information and related permissions, of user-related friends of the product-seeking user to the product-seeking user in the various locations.

Preferably, the identifying is performed in at least one locality selected from the group consisting of: a merchant site, an off-line store, the social-network product-review site-server, an electronic kiosk, and an end-user system.

Preferably, the merchant locations include localities selected from the group consisting of: a merchant site, an off-line store, and a service-provider location.

Preferably, the collecting is performed in at least one locality selected from the group consisting of: a merchant site, an off-line store, the social-network product-review site-server, an electronic kiosk, and an end-user system.

Preferably, the collecting includes transmitting the purchase details and the associated-user identities to the social-network product-review site-server.

Most preferably, the transmitting is performed using a communication transmittal selected from the group consisting of: an SMS, an e-mail, and a web-interface transmittal, a keypad sequence, and a voice response.

Most preferably, the transmitting is performed by automatically generating a communication transmittal.

Preferably, the associated-user identities include at least one identification selected from the group consisting of: a user name in the social-network product-review site-server, a user e-mail address, a user phone number, a user address, an end-user system ID, an e-mail address in the social-network product-review site-server, a magnetic-card ID, a cookie, and a flash shared-object.

Preferably, the collecting and identifying include parsing receipt-related e-mails of the product purchases in order to obtain the purchase details and the associated-user identities.

Most preferably, the receipt-related e-mails are transmitted to the social-network product-review site-server using an e-mail address in the social-network product-review site-server.

Preferably, the notification includes at least one communication transmittal selected from the group consisting of: an SMS, an e-mail, a web-interface transmittal, a messaging-service notification, a pop-up window, a desktop application notification, and a voice message.

Preferably, the user-specific product review and the related-product reviews each include at least one item selected from the group consisting of: the purchase details, a portion of the purchase details, a purchase experience, and a portion of the purchase experience.

Preferably, the permissions are configured: (a) to designate which review portions, of the user-specific product review, and which identity portions, of the relevant associated-user identity, to share; and (b) to designate with which user-related friends to share the portions.

More preferably, the portions are presented according to a rule based on a criterion selected from the group consisting of: a user wish list, a friend wish list, a user purchase-experience history, and a friend purchase-experience history.

Most preferably, the rule is configured to be automatically modified based on a user tendency to read certain related-product reviews from certain user-related friends.

Preferably, the product-related information includes at least one item selected from the group consisting of: a product name, a product category, a product search, a product-category search, a product ID, a product barcode, a manufacturer's name, a manufacturer's location, a product review, a product-related article, a merchant name, a merchant category, and a merchant location.

Preferably, at least one enabled site is a locality selected from the group consisting of: a merchant site, a merchant portal, a product-comparison site, a customer-review site, a general-content site, a banner site, a social-network site, a blog site, a start page, a search-engine site, an off-line store, and an electronic kiosk.

Preferably, the determining and ascertaining is performed in at least one locality selected from the group consisting of: a merchant site, a merchant portal, a product-comparison site, a customer-review site, a general-content site, a banner site, a social-network site, a blog site, a start page, a search-engine site, an off-line store, an electronic kiosk, an end-user system, and the social-network product-review site-server.

Preferably, the identity include at least one identification selected from the group consisting of: a user name in the social-network product-review site-server, a user e-mail address, a user phone number, a user address, an e-mail address in the social-network product-review site-server, and a user photo.

Preferably, the presenting includes presenting using at least one presentation transmittal selected from the group consisting of: an SMS, an e-mail, a web-interface transmittal, a messaging-service notification, a pop-up window, a desktop application notification, and a voice message.

According to the present invention, there is provided for the first time a module for facilitating electronic commerce using a social network, the module configured: (a) to identify product purchases, of a plurality of users, made in merchant locations, wherein at least two users have designated each other as friends in a social-network product-review site; (b) to collect purchase details, of the product purchases, and associated-user identities; (c) to determine product-related information being accessed in various locations by a product-seeking user, wherein the various locations include at least one enabled site and the social-network product-review site; (d) to ascertain an identity of the product-seeking user; and (e) to present related-product reviews, based on the product-related information and related permissions, of user-related friends of the product-seeking user to the product-seeking user in the various locations.

Preferably, the identifying is performed in at least one locality selected from the group consisting of: a merchant site, an off-line store, the social-network product-review site, an electronic kiosk, and an end-user system.

Preferably, the merchant locations include localities selected from the group consisting of: a merchant site, an off-line store, and a service-provider location.

Preferably, the collecting is performed in at least one locality selected from the group consisting of: a merchant site, an off-line store, the social-network product-review site, an electronic kiosk, and an end-user system.

Preferably, the collecting includes transmitting the purchase details and the associated-user identities to the social-network product-review site.

Most preferably, the transmitting is performed using a communication transmittal selected from the group consisting of: an SMS, an e-mail, and a web-interface transmittal, a keypad sequence, and a voice response.

Most preferably, the transmitting is performed by automatically generating a communication transmittal.

Preferably, the associated-user identities include at least one identification selected from the group consisting of: a user name in the social-network product-review site, a user e-mail address, a user phone number, a user address, an end-user system ID, an e-mail address in the social-network product-review site, a magnetic-card ID, a cookie, and a flash shared-object.

Preferably, the collecting and identifying include parsing receipt-related e-mails of the product purchases in order to obtain the purchase details and the associated-user identities.

Preferably, the receipt-related e-mails are transmitted to the social-network product-review site using an e-mail address in the social-network product-review site.

Preferably, the related-product reviews include at least one item selected from the group consisting of: the purchase details, a portion of the purchase details, a purchase experience, and a portion of the purchase experience.

Preferably, the permissions are configured: (a) to designate which review portions, of the related-product reviews, and which identity portions, of the relevant associated-user identity, to share; and (b) to designate with which user-related friends to share the portions.

More preferably, the portions are presented according to a rule based on a criterion selected from the group consisting of: a user wish list, a friend wish list, a user purchase-experience history, and a friend purchase-experience history.

Most preferably, the rule is configured to be automatically modified based on a user tendency to read certain related-product reviews from certain user-related friends.

Preferably, the product-related information includes at least one item selected from the group consisting of: a product name, a product category, a product search, a product-category search, a product ID, a product barcode, a manufacturer's name, a manufacturer's location, a product review, a product-related article, a merchant name, a merchant category, and a merchant location.

Preferably, at least one enabled site is a locality selected from the group consisting of: a merchant site, a merchant portal, a product-comparison site, a customer-review site, a general-content site, a banner site, a social-network site, a blog site, a start page, a search-engine site, an off-line store, and an electronic kiosk.

Preferably, the determining and ascertaining is performed in at least one locality selected from the group consisting of: a merchant site, a merchant portal, a product-comparison site, a customer-review site, a general-content site, a banner site, a social-network site, a blog site, a start page, a search-engine site, an off-line store, an electronic kiosk, an end-user system, and the social-network product-review site.

Preferably, the identity include at least one identification selected from the V group consisting of: a user name in the social-network product-review site, a user e-mail address, a user phone number, a user address, an e-mail address in the social-network product-review site, and a user photo.

Preferably, the presenting includes presenting using at least one presentation transmittal selected from the group consisting of: an SMS, an e-mail, a web-interface transmittal, a messaging-service notification, a pop-up window, a desktop application notification, and a voice message.

According to the present invention, there is provided for the first time computer-readable storage medium having computer-readable code embodied on the computer-readable storage medium, the computer-readable code including: (a) program code for: (i) identifying product purchases, of a plurality of users, made in merchant locations, wherein at least two users have designated each other as friends in a social-network product-review site; (ii) collecting purchase details, of the product purchases, and associated-user identities; (iii) determining product-related information being accessed in various locations by a product-seeking user, wherein the various locations include at least one enabled site and the social-network product-review site; (iv) ascertaining an identity of the product-seeking user; and (v) presenting related-product reviews, based on the product-related information and related permissions, of user-related friends of the product-seeking user to the product-seeking user in the various locations.

Preferably, the identifying is performed in at least one locality selected from the group consisting of: a merchant site, an off-line store, the social-network product-review site, an electronic kiosk, and an end-user system.

Preferably, the merchant locations include localities selected from the group consisting of: a merchant site, an off-line store, and a service-provider location.

Preferably, the collecting is performed in at least one locality selected from the group consisting of: a merchant site, an off-line store, the social-network product-review site, an electronic kiosk, and an end-user system.

Preferably, the collecting includes transmitting the purchase details and the associated-user identities to the social-network product-review site.

Most preferably, the transmitting is performed using a communication transmittal selected from the group consisting of: an SMS, an e-mail, and a web-interface transmittal, a keypad sequence, and a voice response.

Most preferably, the transmitting is performed by automatically generating a communication transmittal.

Preferably, the associated-user identities include at least one identification selected from the group consisting of: a user name in the social-network product-review site, a user e-mail address, a user phone number, a user address, an end-user system ID, an e-mail address in the social-network product-review site, a magnetic-card ID, a cookie, and a flash shared-object.

Preferably, the collecting and identifying include parsing receipt-related e-mails of the product purchases in order to obtain the purchase details and the associated-user identities.

Most preferably, the receipt-related e-mails are transmitted to the social-network product-review site using an e-mail address in the social-network product-review site.

Preferably, the related-product reviews include at least one item selected from the group consisting of: the purchase details, a portion of the purchase details, a purchase experience, and a portion of the purchase experience.

Preferably, the permissions are configured: (a) to designate which review portions, of the related-product reviews, and which identity portions, of the relevant associated-user identity, to share; and (b) to designate with which user-related friends to share the portions.

More preferably, the portions are presented according to a rule based on a criterion selected from the group consisting of: a user wish list, a friend wish list, a user purchase-experience history, and a friend purchase-experience history.

Most preferably, the rule is configured to be automatically modified based on a user tendency to read certain related-product reviews from certain user-related friends.

Preferably, the product-related information includes at least one item selected from the group consisting of: a product name, a product category, a product search, a product-category search, a product ID, a product barcode, a manufacturer's name, a manufacturer's location, a product review, a product-related article, a merchant name, a merchant category, and a merchant location.

Preferably, at least one enabled site is a locality selected from the group consisting of: a merchant site, a merchant portal, a product-comparison site, a customer-review site, a general-content site, a banner site, a social-network site, a blog site, a start page, a search-engine site, an off-line store, and an electronic kiosk.

Preferably, the determining and ascertaining is performed in at least one locality selected from the group consisting of: a merchant site, a merchant portal, a product-comparison site, a customer-review site, a general-content site, a banner site, a social-network site, a blog site, a start page, a search-engine site, an off-line store, an electronic kiosk, an end-user system, and the social-network product-review site.

Preferably, the identity include at least one identification selected from the group consisting of: a user name in the social-network product-review site, a user e-mail address, a user phone number, a user address, an e-mail address in the social-network product-review site, and a user photo.

Preferably, the presenting includes presenting using at least one presentation transmittal selected from the group consisting of: an SMS, an e-mail, a web-interface transmittal, a messaging-service notification, a pop-up window, a desktop application notification, and a voice message.

These and further embodiments will be apparent from the detailed description and examples that follow.

### BRIEF DESCRIPTION OF THE DRAWINGS

The present invention is herein described, by way of example only, with reference to the accompanying drawings, wherein:

FIG. 1 is a simplified schematic representation of an exemplary social network for a user A, according to preferred embodiments of the present invention;

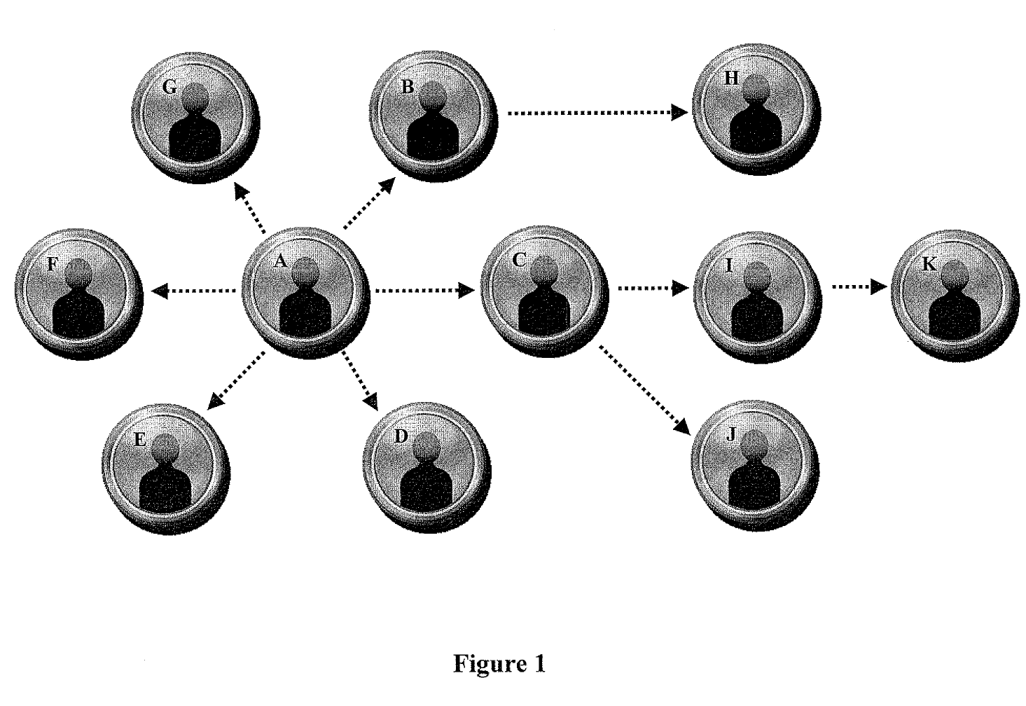

FIG. 2 is a simplified schematic block diagram showing a high-level open architecture of users interfacing with the Blast system, according to preferred embodiments of the present invention;

FIG. 3 is a simplified schematic block diagram showing a high-level closed architecture of users interfacing with the Blast system, according to preferred embodiments of the present invention;

FIG. 4 is a simplified schematic block diagram showing the high-level architecture of users interfacing with the Blast system using a desktop application, according to preferred embodiments of the present invention;

FIG. 5 is a simplified flowchart showing an exemplary process flow of the Blast system, according to preferred embodiments of the present invention.

### DESCRIPTION OF THE PREFERRED EMBODIMENTS

The present invention relates to systems and methods for e-commerce and mobile networks that utilize a social network of acquaintances of a user to provide the user information on purchase experiences of the individuals in the social network. The principles and operation for e-commerce systems and methods that utilize a social network of acquaintances of a user to provide the user information on purchase experiences, according to the present invention, may be better understood with reference to the accompanying description and the drawings.

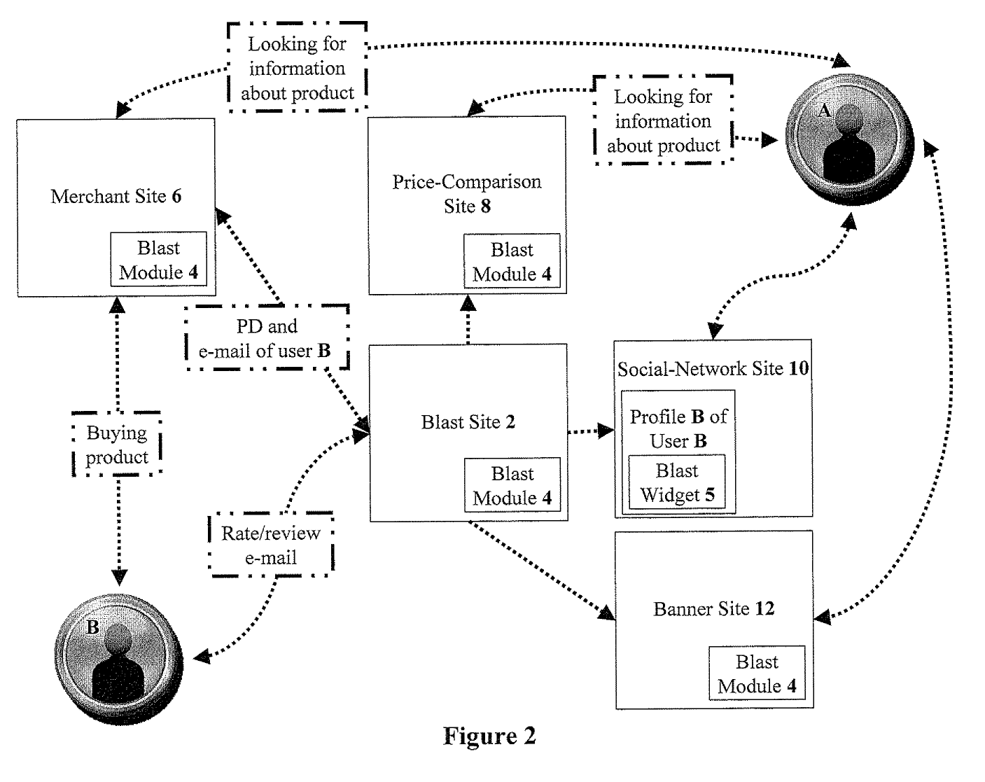

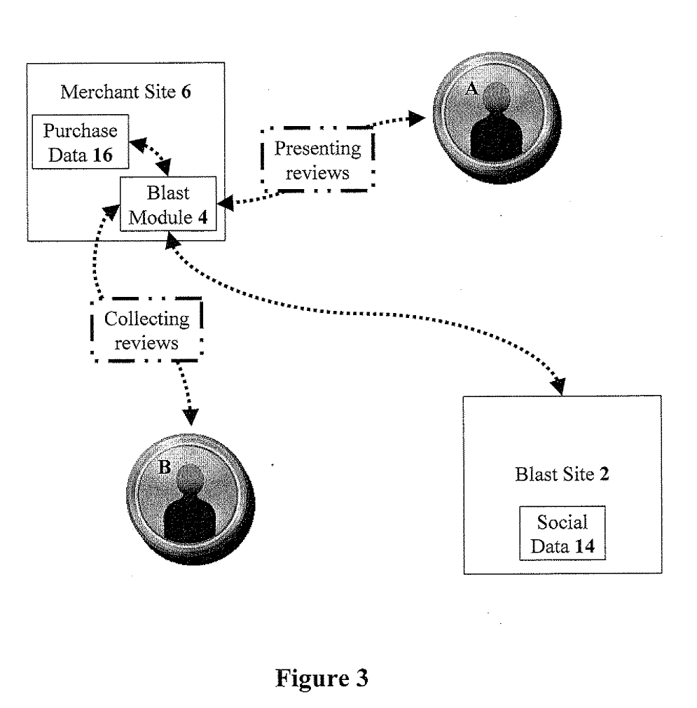

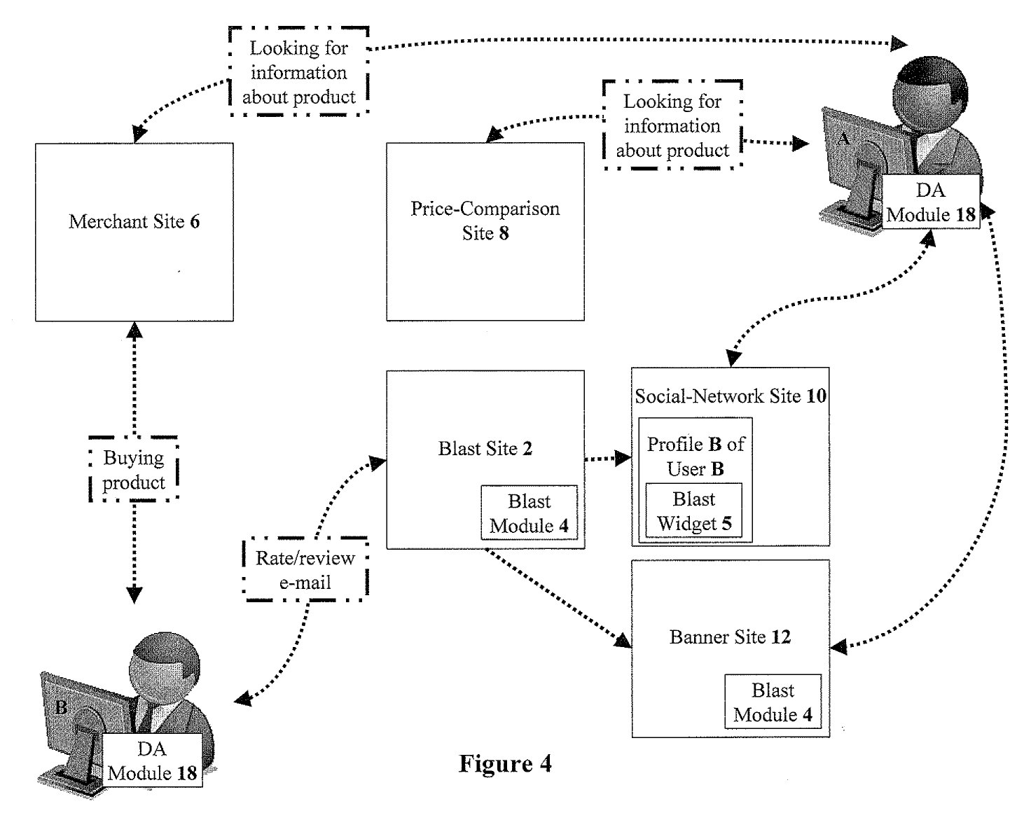

Referring now to the drawings, FIG. 2 is a simplified schematic block diagram showing a high-level open architecture of users interfacing with the Blast system, according to preferred embodiments of the present invention. FIG. 2 (as well as FIGS. 3 and 4) describes the basic data flow, and does not cover all cases described in the Summary.

PE of all blast members is stored in a Blast site 2. Software components, labeled Blast modules 4, are installed in a merchant site 6, in a price-comparison site 8, and in banner code of a banner site 12 in order to enable, among other things, retrieval of the PD. A Blast widget 5 is installed in a social profile B of user B in a social-network site 10. Widget 5 identifies user A as a Blast member, and connects to Blast site 2 in order to retrieve the relevant PE to user B. Widget 5 is also responsible for presenting the PE to user A and to other users of social-network site 10. Blast module 4 in merchant site 6 can be client-based code (e.g. flash or JavaScript) that makes the connection between the end-user system (e.g. PC of user A) and Blast site 2, rather than between a third-party site (e.g. merchant site 6 and price-comparison site 8) and Blast site 2.

User B is shown buying a product from merchant site 6. PE is collected, stored, managed, and presented by Blast site 2. In the example depicted in FIG. 2, User B is identified (e.g. by a cookie or shared object such as a “flash cookie” generated by Blast site 2 or merchant site 6), and the purchase-related PD and e-mail of user B is retrieved from merchant site 6 by Blast site 2. Blast site 2 then sends an automated e-mail notification requesting a rating/review of the product from user B. The notification includes the purchase details and link to a rating/review page in Blast site 2. User A is shown looking for information regarding the same product purchased by user B. If user A designated user B as a friend (and vice versa), and user B designated Blast to share his/her PE with user A, Blast site 2 will provide PE of user B to user A regarding the product. This is performed by Blast module 4, in price-comparison site 8, retrieving the PE from Blast site 2 and presenting the PE in price-comparison site 8.

Blast knows that a purchase occurred and its related PD by one of the following ways.
(1) Blast module 4 (in Blast site 2) receives from merchant site 6 the PD related to the purchase made by user B and the associated information of user B (e.g. name, e-mail, and phone number). The purchase could have been made on- or off-line. Off-line purchase details are reported by the merchant via a reporting mechanism (e.g. Blast web interface or integration to purchase-processing system of the merchant). Users are identified by their Blast ID (e.g. username in Blast, e-mail, cellular number, and magnetic card) which is entered manually, by the merchant or by integration to a magnetic-card identification method, Then, Blast module 4 (in Blast site 2) sends the notification to user B.
(2) User B gives a special e-mail address when providing details in the purchase page of merchant site 6. The special e-mail address (e.g. userB@blast.com) is provided to user B as part of the registration process to the Blast site 2. Receipt of the purchase is sent to Blast site 2. Blast site 2 then automatically determines the purchase details and sends user B the notification to rate/review the purchased product. This approach eliminates the need for explicit technological integration between blast site 2 and merchant site 6 in order for Blast site 2 to identify that a purchase occurred and its related PD. In such a configuration, merchant site 6 is actually unaware of Blast collecting the PD and the following review-request process.

The Blast system consolidates PE that is collected and presented from various sources (e.g. various merchant sites, price-comparison sites, social-network sites, banner sites, service-provider locations, and end-user devices (e.g. cellular, web interface, and e-mail).

For example, users A and B bought products X and V (respectively) from two different merchant sites N and M (respectively). Products X and Y and merchant sites N and M are not shown in FIG. 2. Assuming user A is a friend of user B, user A sees PE of user B regarding product V when user A browses merchant site M and when user A browses merchant site N (or price-comparison site 8). In case that product Y is named differently in merchant site N, Blast site 2 identifies product Y as the same product, and presents user A the PE of user B regarding product Y.

FIG. 3 is a simplified schematic block diagram showing a high-level closed architecture of users interfacing with the Blast system, according to preferred embodiments of the present invention. The architecture is similar to that depicted in FIG. 2, except Blast site 2 does not hold PE or PD related to products of merchant site 6. It mostly includes a social data 14. Social data 14 holds data regarding users' identity and their friends. Blast module 4 is located in merchant site 6, and holds the PE related to products of merchant site 6.

Blast module 4 is responsible for sending notifications to users after purchase, for collecting and storing reviews, identifying Blast members, and presenting to the Blast members reviews of their friends as part of the functionality of merchant site 6. To do so, Blast module 4 gets the purchase information from purchase data 16 in merchant site 6, and the list of friends of each user from social data 14 in Blast site 2. The architecture shown in FIG. 3 enables merchant site 6 to provide some of the Blast capabilities without exposing the PE and PD of its customers to Blast site 2.

FIG. 4 is a simplified schematic block diagram showing the high-level architecture of users interfacing with the Blast system using a desktop application, according to preferred embodiments of the present invention. FIG. 4 shows an alternative way to collect and present PE to users A and B by Blast DA modules 18.

Users A and B have to install DA modules 18 (e.g. browser toolbar, Active X, DA, and desktop gadget) in their systems. DA modules 18 identify (e.g. by URL, http requests, or page content) that user A or B is browsing merchant site 6 or price-comparison site 8 and which product is being browsed (or generally looking for information about a product via a search engine or related article, for example). DA modules 18 provide the relevant PE, retrieved from Blast site 2, in a display-window notification (e.g. pop-up).

In a simplified version of the Blast DA, the user has to activate DA module 18 manually, and enter the name of the product he/she is looking for. DA module 18 is also responsible for collecting the PD. DA module 18 monitors a user's browsing activity. When DA module 18 identifies the user is making an on-line purchase, DA module 18 identifies, with assistance from Blast site 2, what product was purchased, and adds the purchase details to Blast site 2. Then, the user is notified to rate/review the product, and share the PE with other Blast members (i.e. the user's friends). The notification can be via e-mail, SMS, or by DA module 18 itself, for example. In this architecture, there are no Blast modules 4 located in merchant site 6 or price-comparison site 8.

An example of how a hybrid architecture operates is described as follows. User A uses DA module 18 that collects his/her on-line PD. DA module 18 notifies user A to rate/review and share the PE. When user A browses websites, DA module 18 provides user A with related PE from friends about the products he/she is browsing (as in the architecture of FIG. 4). Some sites are integrated with Blast, such that when user A browses such sites, user A sees his/her friends' PE embedded in the pages of the website via Blast module 4 installed in browsed site, rather than presented by DA module.

When user B, a friend of user A, purchases a product off-line in a retail store (not shown), user B provides his/her Blast ID, and the retail-store agent enters the purchase details into a store system (not shown) (e.g. electronic kiosk). The store system sends the ID of user B and related PD to Blast site 2 (e.g. via a web interface). User B is notified to rate/review and share the PE (e.g. by e-mail or SMS). User A then sees the PE of user B in his/her DA module 18 (i.e. on the system of user A).

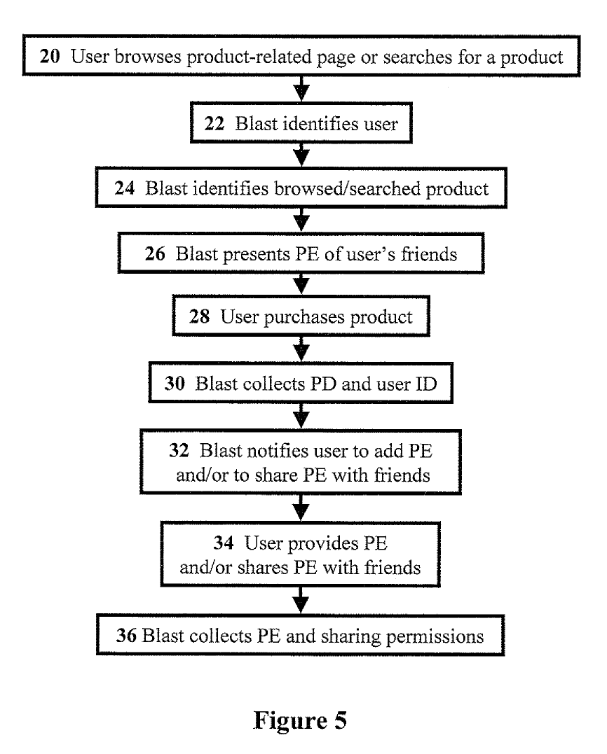

FIG. 5 is a simplified flowchart showing an exemplary process flow of the Blast system, according to preferred embodiments of the present invention. FIG. 5 presents a common sequence of actions performed by a Blast user, and the related actions performed by the Blast system.

First, a user browses a product via one of the following ways (Step 20):
(1) user browses a web page that is related to a product (i.e. the content of the page has a semantic relation to a specific product or category of products) in a merchant site, price-comparison site, product-review site, other content-related site;
(2) user browses a web page with a banner that is embedded with a Blast module;
(3) user searches for information about a product via a search engine (e.g. google.com), Blast DA, Blast widget, or Blast site; or
(4) user browses products in a brick-and-mortar store.

The Blast system identifies the user browsing or searching for product information (Step 22). If the user is using the Blast DA, the DA already knows the user's identity, and reports the identity to the Blast site. If the user browses an on-line site that has an integrated Blast module, the Blast module identifies the user via a Blast-related cookie/flash shared-object that was previously placed on the user's system, or by a login process (e.g. username and password).

The Blast system identifies what is the related product/category in the web page that the user is browsing (Step 24). If user is using the Blast DA, the DA reports the browsed URL to the Blast site. The Blast site maintains a map between the URL and the related product in the URL-related web page. The DA also recognizes search queries that the user enters in search engines.

If the user browses an on-line site that has an integrated Blast module, the Blast module identifies the browsed product or browsed URL, and reports product/URL to the Blast site. If the user is browsing in a brick-and-mortar store, the user uses a cellular interface to capture an image of the product barcode, or to type the product ID in SMS, for example. The information is communicated to the Blast site which identifies the product being browsed.

The Blast site then queries its database with the identified browsed/searched product and identified user, and gets the relevant PE of the user's friends.

The relevant PE is presented to the user via one of the following ways (depending on how Blast identified the browsed product) (Step 26):
(1) via the Blast DA;
(2) via a Blast module integrated in a participating site;
(3) via a Blast widget integrated in a social-network site;
(4) via the Blast site; or
(5) via a mobile device of the user.

The user can then decide to purchase a product either on- or off-line (Step 28). The Blast system identifies a purchase occurred, and collects PD and related user information (Step 30).

If the user is using the Blast DA, the DA identifies his/her browsing behavior by tracing http requests and content of browsed pages. For example, the DA identifies when the user activates the “add to shopping cart” mechanism in a merchant site, or the DA parses the content of the “shopping cart”-related page. Typically, merchant sites present users with a page that consolidates all products that the user added to his/her shopping cart. The DA may assist the Blast site by parsing such information.

If user purchased a product from an on-line merchant site that has an integrated Blast module, the Blast module identifies the PD and ID of the user, and sends the information to the Blast site.

Alternatively, the user can provide a special e-mail address when providing details in the purchase page of a merchant site. The special e-mail address (e.g. user@blast.com) is provided to user as part of the registration process to the Blast system. An electronic receipt of the purchase is sent to the Blast site. The Blast site then automatically determines the PD. In case the user forgets to use his/her Blast-related e-mail address by using a regular e-mail address, the user can forward the receipt from his/her e-mail account to the Blast site where the receipt is received and parsed.

In an off-line purchase, the merchant asks for the user's permission, and updates the Blast system with the PD and user ID in the Blast site (e.g. via web interface, cellular interface (e.g. SMS, picture of product barcode), voice-response, keypad sequence, and/or magnetic card).

The Blast site notifies the user to provide a rating/review for a purchase, and to specify which information to share with which friends (Step 32). The user, for example, might prefer to avoid sharing his/her identity with regard to a product that the user purchased, but is willing to share his/her PE about the product.

The user receives an automated notification requesting him/her to review or rate the purchased product. The PD appear in the notification. The user reviews or rates the product, and gives permission to present the PE to his/her friends (Step 34).

Notification and reviews can be delivered, for example, via an e-mail, an SMS, a messaging system (e.g. Instant Messenger), a voice message, the Blast widget for social networks and blogs, a keypad sequence, the Blast DA, a widget in the starting page (e.g. Netvibes), and/or the Blast site. The Blast system then stores the PE and information-sharing permissions that the user provided (Step 36).

All the steps in FIG. 5 are not required to be performed; a user can decide to stop the process at any stage. For example, the user might decide to just browse product-related pages (Step 20) without making a purchase.

While the invention has been described with respect to a limited number of embodiments, it will be appreciated that many variations, modifications, and other applications of the invention may be made.

What is claimed is:

1. A method for facilitating electronic commerce using a social network, the method comprising the steps of:
(a) registering a plurality of users on a social-network product-review site, wherein each said user can be communicationally connected to other said users by designating said other users as friends;
(b) identifying product purchases, of said plurality of users, made in merchant locations;
(c) collecting purchase details, of said product purchases, and associated-user identities;
(d) sending a notification to an associated said user requesting a user-specific product review from said associated user upon said associated user receiving said purchase details associated with said associated user;
(e) obtaining said user-specific product review and permissions from said associated user, wherein said permissions designate to share said user-specific product review and a relevant said associated-user identity with associated-user said friends;
(f) determining product-related information being accessed in various locations by a product-seeking said user, wherein said various locations include at least one enabled site and said social-network product-review site;
(g) ascertaining an identity of said product-seeking user; and
(h) presenting related-product reviews, based on said product-related information and related said permissions, of user-related said friends of said product-seeking user to said product-seeking user in said various locations.

2. The method of claim 1, wherein said step of identifying is performed in at least one locality selected from the group consisting of: a merchant site, an off-line store, said social-network product-review site, an electronic kiosk, and an end-user system.

3. The method of claim 1, wherein said merchant locations include localities selected from the group consisting of: a merchant site, an off-line store, and a service-provider location.

4. The method of claim 1, wherein said step of collecting is performed in at least one locality selected from the group consisting of: a merchant site, an off-line store, said social-network product-review site, an electronic kiosk, and an end-user system.

5. The method of claim 1, wherein said step of collecting includes transmitting said purchase details and said associated-user identities to said social-network product-review site.

6. The method of claim 5, wherein said transmitting is performed using a communication transmittal selected from the group consisting of: an SMS, an e-mail, and a web-interface transmittal, a keypad sequence, and a voice response.

7. The method of claim 5, wherein said transmitting is performed by automatically generating a communication transmittal.

8. The method of claim 1, wherein said associated-user identities include at least one identification selected from the group consisting of: a user name in said social-network product-review site, a user e-mail address, a user phone number, a user address, an end-user system ID, an e-mail address in said social-network product-review site, a magnetic-card ID, a cookie, and a flash shared-object.

9. The method of claim 1, wherein said steps of collecting and identifying include parsing receipt-related e-mails of said product purchases in order to obtain said purchase details and said associated-user identities.

10. The method of claim 9, wherein said receipt-related e-mails are transmitted to said social-network product-review site using an e-mail address in said social-network product-review site.

11. The method of claim 1, wherein said notification includes at least one communication transmittal selected from the group consisting of: an SMS, an e-mail, a web-interface transmittal, a messaging-service notification, a pop-up window, a desktop application notification, and a voice message.

12. The method of claim 1, wherein said user-specific product review and said related-product reviews each include at least one item selected from the group consisting of: said purchase details, a portion of said purchase details, a purchase experience, and a portion of said purchase experience.

13. The method of claim 1, wherein said permissions are configured:
(a) to designate which review portions, of said user-specific product review, and which identity portions, of said relevant associated-user identity, to share; and
(b) to designate with which said user-related friends to share said portions.

14. The method of claim 13, wherein said portions are presented according to a rule based on a criterion selected from the group consisting of: a user wish list, a friend wish list, a user purchase-experience history, and a friend purchase-experience history.

15. The method of claim 14, wherein said rule is configured to be automatically modified based on a user tendency to read certain said related-product reviews from certain said user-related friends.

16. The method of claim 1, wherein said product-related information includes at least one item selected from the group consisting of: a product name, a product category, a product search, a product-category search, a product ID, a product barcode, a manufacturer's name, a manufacturer's location, a product review, a product-related article, a merchant name, a merchant category, and a merchant location.

17. The method of claim 1, wherein said at least one enabled site is a locality selected from the group consisting of: a merchant site, a merchant portal, a product-comparison site, a customer-review site, a general-content site, a banner site, a social-network site, a blog site, a start page, a search-engine site, an off-line store, and an electronic kiosk.

18. The method of claim 1, wherein said steps of determining and ascertaining is performed in at least one locality selected from the group consisting of: a merchant site, a merchant portal, a product-comparison site, a customer-review site, a general-content site, a banner site, a social-network site, a blog site, a start page, a search-engine site, an off-line store, an electronic kiosk, an end-user system, and said social-network product-review site.

19. The method of claim 1, wherein said identity include at least one identification selected from the group consisting of: a user name in said social-network product-review site, a user e-mail address, a user phone number, a user address, an e-mail address in said social-network product-review site, and a user photo.

20. The method of claim 1, wherein said step of presenting includes presenting using at least one presentation transmittal selected from the group consisting of: an SMS, an e-mail, a web-interface transmittal, a messaging-service notification, a pop-up window, a desktop application notification, and a voice message.

21. A system for facilitating electronic commerce using a social network, the system comprising:
(a) a social-network product-review site-server configured:
(i) to register a plurality of users, wherein each said user can be communicationally connected to other said users by designating said other users as friends;
(ii) to send a notification to an associated said user requesting a user-specific product review from said associated user upon said associated user receiving purchase details associated with said associated user; and
(iii) to obtain said user-specific product review and permissions from said associated user, wherein said permissions designate to share said user-specific product review and a relevant associated-user identity with associated-user said friends; and
(b) a module configured:
(i) to identify product purchases, of said plurality of users, made in merchant locations;
(ii) to collect said purchase details, of said product purchases, and associated-user identities;
(iii) to determine product-related information being accessed in various locations by a product-seeking said user, wherein said various locations include at least one enabled site and said social-network product-review site-server;
(iv) to ascertain an identity of said product-seeking user; and
(v) to present related-product reviews, based on said product-related information and related said permissions, of user-related said friends of said product-seeking user to said product-seeking user in said various locations.

22. The system of claim 21, wherein said identifying is performed in at least one locality selected from the group consisting of: a merchant site, an off-line store, said social-network product-review site-server, an electronic kiosk, and an end-user system.

23. The system of claim 21, wherein said merchant locations include localities selected from the group consisting of: a merchant site, an off-line store, and a service-provider location.

24. The system of claim 21, wherein said collecting is performed in at least one locality selected from the group consisting of: a merchant site, an off-line store, said social-network product-review site-server, an electronic kiosk, and an end-user system.

25. The system of claim 21, wherein said collecting includes transmitting said purchase details and said associated-user identities to said social-network product-review site-server.

26. The system of claim 25, wherein said transmitting is performed using a communication transmittal selected from the group consisting of: an SMS, an e-mail, and a web-interface transmittal, a keypad sequence, and a voice response.

27. The system of claim 25, wherein said transmitting is performed by automatically generating a communication transmittal.

28. The system of claim 21, wherein said associated-user identities include at least one identification selected from the group consisting of: a user name in said social-network product-review site-server, a user e-mail address, a user phone number, a user address, an end-user system ID, an e-mail address in said social-network product-review site-server, a magnetic-card ID, a cookie, and a flash shared-object.

29. The system of claim 21, wherein said collecting and identifying include parsing receipt-related e-mails of said product purchases in order to obtain said purchase details and said associated-user identities.

30. The system of claim 29, wherein said receipt-related e-mails are transmitted to said social-network product-review site-server using an e-mail address in said social-network product-review site-server.

31. The system of claim 21, wherein said notification includes at least one communication transmittal selected from the group consisting of: an SMS, an e-mail, a web-interface transmittal, a messaging-service notification, a pop-up window, a desktop application notification, and a voice message.

32. The system of claim 21, wherein said user-specific product review and said related-product reviews each include at least one item selected from the group consisting of: said purchase details, a portion of said purchase details, a purchase experience, and a portion of said purchase experience.

33. The system of claim 21, wherein said permissions are configured:
(a) to designate which review portions, of said user-specific product review, and which identity portions, of said relevant associated-user identity, to share; and
(b) to designate with which said user-related friends to share said portions.

34. The system of claim 33, wherein said portions are presented according to a rule based on a criterion selected from the group consisting of: a user wish list, a friend wish list, a user purchase-experience history, and a friend purchase-experience history.

35. The system of claim 34, wherein said rule is configured to be automatically modified based on a user tendency to read certain said related-product reviews from certain said user-related friends.

36. The system of claim 21, wherein said product-related information includes at least one item selected from the group consisting of: a product name, a product category, a product search, a product-category search, a product ID, a product barcode, a manufacturer's name, a manufacturer's location, a product review, a product-related article, a merchant name, a merchant category, and a merchant location.

37. The system of claim 21, wherein said at least one enabled site is a locality selected from the group consisting of: a merchant site, a merchant portal, a product-comparison site, a customer-review site, a general-content site, a banner site, a social-network site, a blog site, a start page, a search-engine site, an off-line store, and an electronic kiosk.

38. The system of claim 21, wherein said determining and ascertaining is performed in at least one locality selected from the group consisting of: a merchant site, a merchant portal, a product-comparison site, a customer-review site, a general-content site, a banner site, a social-network site, a blog site, a start page, a search-engine site, an off-line store, an electronic kiosk, an end-user system, and said social-network product-review site-server.

39. The system of claim 21, wherein said identity include at least one identification selected from the group consisting of: a user name in said social-network product-review site-server, a user e-mail address, a user phone number, a user address, an e-mail address in said social-network product-review site-server, and a user photo.

40. The system of claim 21, wherein said presenting includes presenting using at least one presentation transmittal selected from the group consisting of: an SMS, an e-mail, a web-interface transmittal, a messaging-service notification, a pop-up window, a desktop application notification, and a voice message.

41. A module for facilitating electronic commerce using a social network, the module configured:
(a) to identify product purchases, of a plurality of users, made in merchant locations, wherein at least two said users have designated each other as friends in a social-network product-review site;
(b) to collect purchase details, of said product purchases, and associated-user identities;
(c) to determine product-related information being accessed in various locations by a product-seeking said user, wherein said various locations include at least one enabled site and said social-network product-review site;
(d) to ascertain an identity of said product-seeking user; and
(e) to present related-product reviews, based on said product-related information and related permissions, of user-related said friends of said product-seeking user to said product-seeking user in said various locations.

42. The module of claim 41, wherein said identifying is performed in at least one locality selected from the group consisting of: a merchant site, an off-line store, said social-network product-review site, an electronic kiosk, and an end-user system.

43. The module of claim 41, wherein said merchant locations include localities selected from the group consisting of: a merchant site, an off-line store, and a service-provider location.

44. The module of claim 41, wherein said collecting is performed in at least one locality selected from the group consisting of: a merchant site, an off-line store, said social-network product-review site, an electronic kiosk, and an end-user system.

45. The module of claim 41, wherein said collecting includes transmitting said purchase details and said associated-user identities to said social-network product-review site.

46. The module of claim 45, wherein said transmitting is performed using a communication transmittal selected from the group consisting of: an SMS, an e-mail, and a web-interface transmittal, a keypad sequence, and a voice response.

47. The module of claim 45, wherein said transmitting is performed by automatically generating a communication transmittal.

48. The module of claim 41, wherein said associated-user identities include at least one identification selected from the group consisting of: a user name in said social-network product-review site, a user e-mail address, a user phone number, a user address, an end-user system ID, an e-mail address in said social-network product-review site, a magnetic-card ID, a cookie, and a flash shared-object.

49. The module of claim 41, wherein said collecting and identifying include parsing receipt-related e-mails of said product purchases in order to obtain said purchase details and said associated-user identities.

50. The module of claim 49, wherein said receipt-related e-mails are transmitted to said social-network product-review site using an e-mail address in said social-network product-review site.

51. The module of claim 41, wherein said related-product reviews include at least one item selected from the group consisting of: said purchase details, a portion of said purchase details, a purchase experience, and a portion of said purchase experience.

52. The module of claim 41, wherein said permissions are configured:
(a) to designate which review portions, of said related-product reviews, and which identity portions, of said relevant associated-user identity, to share; and
(b) to designate with which said user-related friends to share said portions.

53. The module of claim 52, wherein said portions are presented according to a rule based on a criterion selected from the group consisting of: a user wish list, a friend wish list, a user purchase-experience history, and a friend purchase-experience history.

54. The module of claim 53, wherein said rule is configured to be automatically modified based on a user tendency to read certain said related-product reviews from certain said user-related friends.

55. The module of claim 41, wherein said product-related information includes at least one item selected from the group consisting of: a product name, a product category, a product search, a product-category search, a product ID, a product barcode, a manufacturer's name, a manufacturer's location, a product review, a product-related article, a merchant name, a merchant category, and a merchant location.

56. The module of claim 41, wherein said at least one enabled site is a locality selected from the group consisting of: a merchant site, a merchant portal, a product-comparison site, a customer-review site, a general-content site, a banner site, a social-network site, a blog site, a start page, a search-engine site, an off-line store, and an electronic kiosk.

57. The module of claim 41, wherein said determining and ascertaining is performed in at least one locality selected from the group consisting of: a merchant site, a merchant portal, a product-comparison site, a customer-review site, a general-content site, a banner site, a social-network site, a blog site, a start page, a search-engine site, an off-line store, an electronic kiosk, an end-user system, and said social-network product-review site.

58. The module of claim 41, wherein said identity include at least one identification selected from the group consisting of: a user name in said social-network product-review site, a user e-mail address, a user phone number, a user address, an e-mail address in said social-network product-review site, and a user photo.

59. The module of claim 41, wherein said presenting includes presenting using at least one presentation transmittal selected from the group consisting of: an SMS, an e-mail, a web-interface transmittal, a messaging-service notification, a pop-up window, a desktop application notification, and a voice message.

60. A computer-readable storage medium having computer-readable code embodied on the computer-readable storage medium, the computer-readable code comprising:
(a) program code for:
(i) identifying product purchases, of a plurality of users, made in merchant locations, wherein at least two said users have designated each other as friends in a social-network product-review site;
(ii) collecting purchase details, of said product purchases, and associated-user identities;
(iii) determining product-related information being accessed in various locations by a product-seeking said user, wherein said various locations include at least one enabled site and said social-network product-review site;
(iv) ascertaining an identity of said product-seeking user; and
(v) presenting related-product reviews, based on said product-related information and related permissions, of user-related said friends of said product-seeking user to said product-seeking user in said various locations.

61. The storage medium of claim 60, wherein said identifying is performed in at least one locality selected from the group consisting of: a merchant site, an off-line store, said social-network product-review site, an electronic kiosk, and an end-user system.

62. The storage medium of claim 60, wherein said merchant locations include localities selected from the group consisting of: a merchant site, an off-line store, and a service-provider location.

63. The storage medium of claim 60, wherein said collecting is performed in at least one locality selected from the group consisting of: a merchant site, an off-line store, said social-network product-review site, an electronic kiosk, and an end-user system.

64. The storage medium of claim 60, wherein said collecting includes transmitting said purchase details and said associated-user identities to said social-network product-review site.

65. The storage medium of claim 64, wherein said transmitting is performed using a communication transmittal selected from the group consisting of: an SMS, an e-mail, and a web-interface transmittal, a keypad sequence, and a voice response.

66. The storage medium of claim 64, wherein said transmitting is performed by automatically generating a communication transmittal.

67. The storage medium of claim 60, wherein said associated-user identities include at least one identification selected from the group consisting of: a user name in said social-network product-review site, a user e-mail address, a user phone number, a user address, an end-user system TD, an e-mail address in said social-network product-review site, a magnetic-card ID, a cookie, and a flash shared-object.

68. The storage medium of claim 60, wherein said collecting and identifying include parsing receipt-related e-mails of said product purchases in order to obtain said purchase details and said associated-user identities.

69. The storage medium of claim 68, wherein said receipt-related e-mails are transmitted to said social-network product-review site using an e-mail address in said social-network product-review site.

70. The storage medium of claim 60, wherein said related-product reviews include at least one item selected from the group consisting of: said purchase details, a portion of said purchase details, a purchase experience, and a portion of said purchase experience.

71. The storage medium of claim 60, wherein said permissions are configured:
(a) to designate which review portions, of said related-product reviews, and which identity portions, of said relevant associated-user identity, to share; and
(b) to designate with which said user-related friends to share said portions.

72. The storage medium of claim 71, wherein said portions axe presented according to a rule based on a criterion selected from the group consisting of: a user wish list, a friend wish list, a user purchase-experience history, and a friend purchase-experience history.

73. The storage medium of claim 72, wherein said rule is configured to be automatically modified based on a user tendency to read certain said related-product reviews from certain said user-related friends.

74. The storage medium of claim 60, wherein said product-related information includes at least one item selected from the group consisting of: a product name, a product category, a product search, a product-category search, a product ID, a product barcode, a manufacturer's name, a manufacturer's location, a product review, a product-related article, a merchant name, a merchant category, and a merchant location.

75. The storage medium of claim 60, wherein said at least one enabled site is a locality selected from the group consisting of: a merchant site, a merchant portal, a product-comparison site, a customer-review site, a general-content site, a banner site, a social-network site, a blog site, a start page, a search-engine site, an off-line store, and an electronic kiosk.

76. The storage medium of claim 60, wherein said determining and ascertaining is performed in at least one locality selected from the group consisting of: a merchant site, a merchant portal, a product-comparison site, a customer-review site, a general-content site, a banner site, a social-network site, a blog site, a start page, a search-engine site, an off-line store, an electronic kiosk, an end-user system, and said social-network product-review site.

77. The storage medium of claim 60, wherein said identity include at least one identification selected from the group consisting of: a user name in said social-network product-review site, a user e-mail address, a user phone number, a user address, an e-mail address in said social-network product-review site, and a user photo.

78. The storage medium of claim 60, wherein said presenting includes presenting using at least one presentation transmittal selected from the group consisting of: an SMS, an e-mail, a web-interface transmittal, a messaging-service notification, a pop-up window, a desktop application notification, and a voice message.
